(19) United States
(12) Patent Application Publication
(10) Pub. No.: US 2008/0036857 A1
(43) Pub. Date: Feb. 14, 2008

(54) Video Image Positional Relationship Correction Apparatus, Steering Assist Apparatus Having the Video Image Positional Relationship Correction Apparatus and Video Image Positional Relationship Correction Method

(76) Inventor: Kazunori Shimazaki, Aichi (JP)

Correspondence Address: MORGAN & FINNEGAN, L.L.P., 3 WORLD FINANCIAL CENTER, NEW YORK, NY, 10281-2101, US

(21) Appl. No.: 10/587,291

(22) PCT Filed: Oct. 29, 2004
(86) PCT No.: PCT/JP04/16454

§ 371 Date: Apr. 13, 2007

(30) Foreign Application Priority Data
Jan. 30, 2004 (JP) 2004-023673

(51) Int. Cl. H04N 7/18

(52) U.S. Cl. 348/113

(57) ABSTRACT

A video image positional relationship correction apparatus is disclosed. Coordinate conversion parameters including internal parameters of a camera and attachment parameters are used as unknown numbers. Relational expressions are produced such that the number of the relational expressions is larger than the number of the coordinate conversion parameters to be calculated. Values of the coordinate conversion parameters are calculated based on deviations between monitor coordinates of video image reference points Q1 to Q6 actually captured by the camera and displayed, and the corresponding monitor coordinates of virtual target points R1 to R6. The monitor coordinates of the virtual target points are derived from the actual coordinates of the reference points based on the values of the calculated coordinate conversion parameters. The coordinate conversion parameters are determined such that the square-sum of the deviations between the monitor coordinates of the virtual target points and the monitor coordinates of the actually captured video image reference points is the minimum. Based on the determined values of the coordinate conversion parameters, the relative positional relationship between the actual video image and the virtual video image is corrected.

### TECHNICAL FIELD TO WHICH THE INVENTION BELONGS

The present invention relates to a video image positional relationship correction apparatus and a video image positional relationship correction method for correcting relative positional relationship between an actual image and a virtual image. Further, the present invention also relates to a steering assist apparatus having the video image positional relationship correction apparatus.

### PRIOR ART

Conventionally, a driving assist apparatus for assisting driving operation as disclosed, e.g., in JP 2002-251632 A has been developed, which captures an actual video image at the back of a vehicle using a CCD camera, displays the captured video image on a monitor screen, and displays an estimated driving path at the time of rearward movement of the vehicle on the monitor screen by superimposing the captured video image and the estimated driving path on the monitor screen in accordance with information about the tire steering angle or the like detected by a sensor. Using the driving assist apparatus, for example, the driver can view the estimated driving path on the monitor screen to carry out parallel parking of the vehicle in a parking space.

However, when an optical axis of a lens constituting the CCD camera is not in alignment with a center of the CCD area sensor, or if the CCD camera is not attached to the vehicle at an appropriate position, the center of the video image at the back of the vehicle and the center of the monitor screen for drawing the estimated driving path do not match with each other on the monitor screen. Therefore, the estimated driving path may be deviated from a proper positional relationship with the video image at the back of the vehicle.

Under the circumstances, it may not be possible to carry out the desired backward movement or parking of the vehicle even along with the estimated driving path. Therefore, generally, adjustment of the relative positional relationship between the CCD sensor and the lens (adjustment of the optical axis) is carried out, and the attachment condition of the CCD camera is adjusted for each vehicle such that the CCD camera is properly attached to the vehicle in accordance with references.

### PROBLEM TO BE SOLVED BY THE INVENTION

However, the above-mentioned adjustment of the optical axis is carried out by physically adjusting the position of the lens at the time of assembling the lens. Therefore, it is difficult to carry out the adjustment of the optical axis with high accuracy. Further, extremely large cost is incurred in order to achieve the higher accuracy.

The present invention has been made to overcome these conventional problems, and an object of the present invention is to provide a video image positional relationship correction apparatus and method thereof which make it possible to properly correct the positional relationship between the actual video image and the virtual video image without requiring physical adjustment of the optical axis.

Further, another object of the present invention is to provide a steering assist apparatus having such a video image positional relationship correction apparatus.

### MEANS FOR SOLVING THE PROBLEM

According to the present invention, an apparatus for correcting relative positional relationship between an actual video image captured by a camera and a virtual video image for use in a video image display device for superimposing the actual video image and the virtual video image on a monitor screen, includes: actual targets set in an actual coordinate system in an area captured by the camera; coordinate conversion means for theoretically deriving monitor coordinates in a monitor coordinate system on the monitor screen by coordinate conversion of actual coordinates of the actual targets in the actual coordinate system based on reference values of coordinate conversion parameters including internal parameters of the camera itself and attachment parameters for attaching the camera to the vehicle; recognition means for recognizing the monitor coordinates of the image of the actual targets actually captured by the camera; and correction means for correcting at least values of the internal parameters of the camera itself of the coordinate conversion parameters based on deviations between the monitor coordinates of the image of the actual targets actually captured by the camera and the corresponding monitor coordinates in the monitor coordinate system of the actual targets which has been subjected to the coordinate conversion, and correcting relative positional relationship between the actual video image and the virtual video image based on the corrected values of the coordinate conversion parameters: the correction means generating relational expressions the number of which is larger than the number of the coordinate conversion parameters based on the monitor coordinates of the image of the actual targets and the monitor coordinates in the monitor coordinate system of the actual targets which have been subjected to coordinate conversion, the coordinate conversion parameters being corrected such that the square-sum of the deviations is the minimum; the number of actual targets being determined such that the number of the relational expressions is larger than the number of the coordinate conversion parameters which require correction.

According to the present invention, a steering assist apparatus includes the above video image positional relationship correction apparatus, in which the actual video image and the virtual video image are a video image at the back of the vehicle, and a steering assist guide, respectively.

Further, according to the present invention, a method of correcting relative positional relationship between an actual video image captured by a camera and a virtual video image when superimposing the actual image and the virtual video image on a monitor screen, includes the steps of: capturing actual targets in an actual coordinate system by the camera; theoretically deriving monitor coordinates in a monitor coordinate system on the monitor screen by coordinate conversion of actual coordinates of the actual targets in the actual coordinate system based on reference values of coordinate conversion parameters including internal parameters of the camera itself and attachment parameters for attaching the camera to the vehicle; recognizing the monitor coordinates of the image of the actual targets actually captured by the camera; generating relational expressions based on deviations between the monitor coordinates of the image of the actual targets and the monitor coordinates in the monitor coordinate system of the actual targets which have been subjected to coordinate conversion, the number of relational expressions being larger than the number of the coordinate conversion parameters to be corrected including at least internal parameters of the camera itself of the coordinate conversion parameters; correcting the coordinate conversion parameters such that the square-sum of the deviations is the minimum; and correcting relative positional relationship between the actual video image and the virtual video image based on the corrected values of the coordinate conversion parameters.

### BRIEF DESCRIPTION OF THE DRAWINGS

FIG. 1 is a view showing a rear portion of a vehicle equipped with a video image positional relationship correction apparatus according to a first embodiment of the present invention;

FIG. 2 is a block diagram showing the structure of the video image positional relationship correction apparatus according to the first embodiment;

FIG. 3 is a front view showing a controller used in the first embodiment;

FIG. 4 is a view showing an image at the back of the vehicle displayed on a screen of a monitor in the first embodiment;

FIGS. 5 and 6 are block diagrams showing video image positional relationship correction apparatuses according to second and third embodiments, respectively; and

FIG. 7 is a side view showing a vehicle equipped with a video image positional relationship correction apparatus according to a fourth embodiment.

### EMBODIMENT MODE FOR CARRYING OUT THE INVENTION

Hereinafter, embodiments of the present invention will be described with reference to the drawings.

In the embodiments described below with reference to the drawings, video image positional relationship correction apparatuses according to the present invention are used for correcting the video image positional relationship between a video image at the back of a vehicle and a steering assist guide in a steering assist apparatus for the vehicle.

### First Embodiment

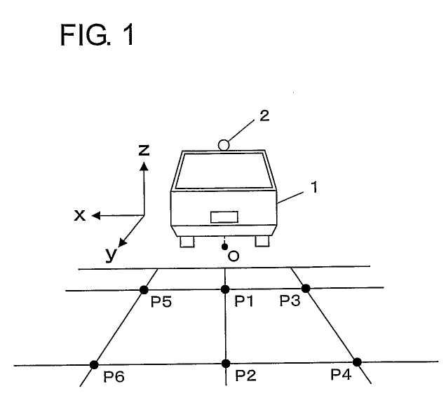

FIG. 1 shows a condition in which a video image positional relationship correction apparatus according to a first embodiment is attached to a vehicle. A CCD camera 2 for capturing a video image at the back of the vehicle is attached to a rear portion of the vehicle 1. On a road surface at the back of the vehicle 1, reference points P1 to P6 set at predetermined positions as actual targets are drawn.

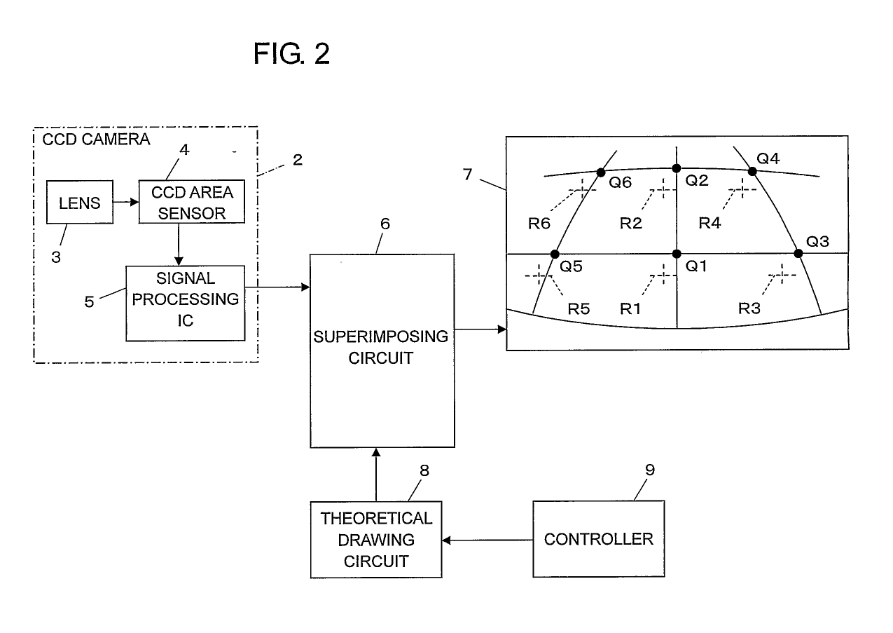

FIG. 2 shows the structure of the video image positional relationship correction apparatus. The CCD camera 2 includes a lens 3, a CCD area sensor 4, and a signal processing IC 5. The signal processing IC 5 is connected to a superimposing circuit 6. The superimposing circuit 6 is connected to a monitor 7 disposed in front of a driver's seat of the vehicle 1. Further, a theoretical drawing circuit 8 is connected to the superimposing circuit 6. A controller 9 is connected to the theoretical drawing circuit 8.

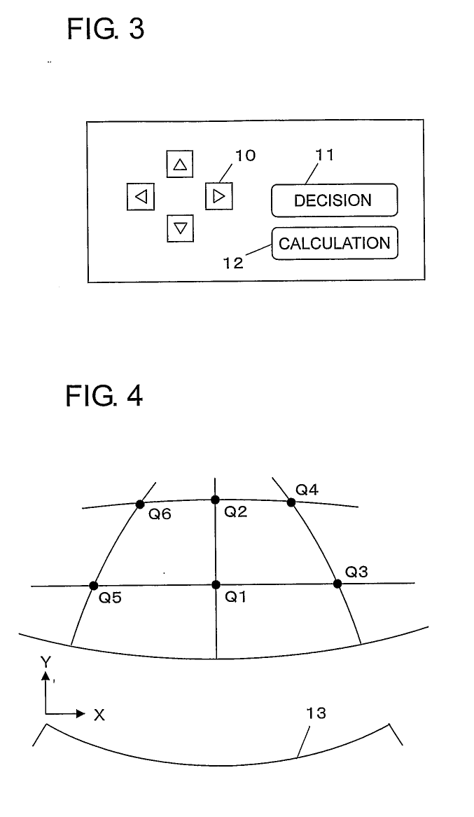

The controller 9 is provided at a position adjacent to the monitor 7 in front of the driver's seat of the vehicle 1. As shown in FIG. 3, the controller 9 includes direction buttons 10 for inputting a correction amount in an up direction a down direction, a left direction, and a right direction by manipulation of the driver, a decision button 11, and a calculation button 12.

The theoretical drawing circuit 8 functions as coordinate conversion means according to the present invention. The theoretical drawing means 8 and the controller 9 function as recognition means and correction means.

At this time, as shown in FIG. 1, a road surface coordinate system (actual coordinate system) including an origin O, a positive y-axis direction, a positive x-axis direction, and a positive z-axis direction is assumed. The origin O is a point on the ground, and defined by extending a vertical line from a center of rear axle toward the road surface. The positive y-axis direction is defined by a horizontal direction toward the back of the vehicle 1. The positive x-axis direction is defined by a horizontal direction on the left side of the vehicle 1, and the positive z-direction is defined by a vertical direction on the upper side of the vehicle 1.

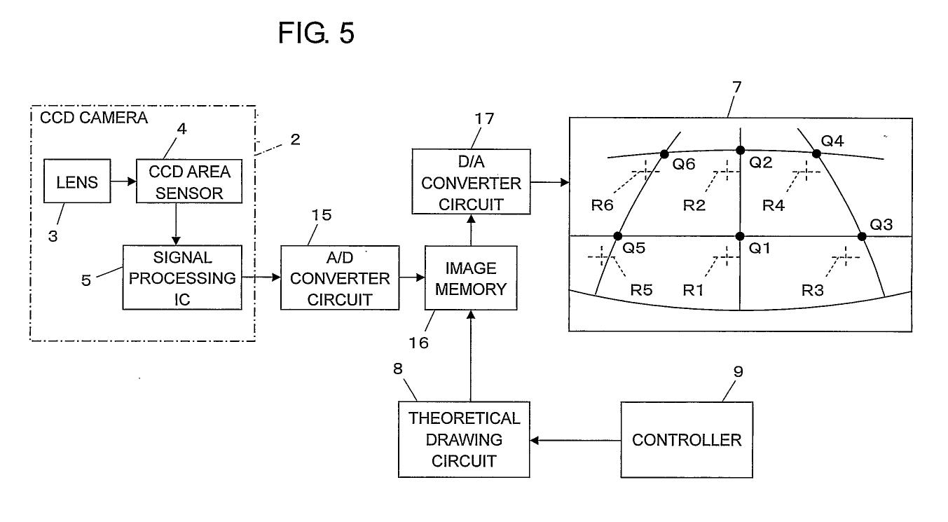

A video image (mirror image) at the back of the vehicle captured by the CCD camera 2 and displayed on the screen of the monitor 7 is shown in FIG. 4. The video image shows a rear bumper 13 of the vehicle 1. A monitor coordinate system including a positive X-axis direction and a positive Y-axis direction is assumed. The positive X-axis direction is defined by a horizontal direction on the right side of the screen. The positive Y-axis direction is defined by a vertical direction on the upper side of the screen.

In performing the coordinate conversion between the road surface coordinate system and the monitor coordinate system, coordinate conversion parameters including attachment parameters for attaching the CCD camera 2 to the vehicle 1 and internal parameters of the CCD camera 2 itself are set.

Firstly, the following parameters are considered as the attachment parameters. When the CCD camera 2 is attached to the vehicle 1 in accordance with references, the CCD camera 2 is installed at a reference attachment position of a coordinate point (x, y, z) expressed by the road coordinate system at a reference attachment angle comprising a tilting angle ω, a direction angle γ, and a rotation angle θ. The tilting angle ω is an angle of downward inclination from the y-axis direction. The direction angle γ is an angle of inclination from a negative y-axis direction in a surface parallel to the xy surface. The rotation angle θ is an angle of attachment by rotating the CCD camera 2 about an optical axis of the lens 3.

However, in reality, the CCD camera 2 is attached to the vehicle with attachment errors with respect to the references. It is assumed that the CCD camera 2 is installed at an attachment position of a coordinate point (x+Δx, y+Δy, z+Δz) in the road surface coordinate system, at an attachment angle comprising a tilting angle ω+Δω, a direction angle γ+Δγ, and a rotation angle θ+Δθ. These parameters x+Δx, y+Δy, z+Δz, ω+Δω, γ+Δγ, θ+Δθ are the attachment parameters for attaching the CCD camera 2.

Further, the internal parameters may include a positional deviation amount ΔCx indicating deviation of the center of the CCD area sensor 4 in the positive x-axis direction with respect to the optical axis of the lens 3, a positional deviation amount ΔCy indicating deviation of the center of the CCD area sensor 4 in the positive y-axis direction with respect to the optical axis of the lens 3, a focus distance f+Δf of the CCD camera 2, and distortion constants Da, Db, Dc.

The distortion constants Da, Db, Dc are constants used in the following equation for defining a distortion coefficient D.

D=[(r−r0)/r0]×100=Da×r²+Db×r+Dc

where r0 is the image height which is determined without taking the distortion into account, r is the image height which is determined taking the distortion into account, and the image height is expressed by the distance from the intersection of the optical axis (extension line from the lens center) and the CCD area sensor surface to a target point on the CCD area sensor.

Further, in addition to these attachment parameters and internal parameters, the coordinate conversion parameters may include conversion constants to the screen of the monitor 7. The conversion constants are the X-axis magnification, the positional deviation in the X-axis direction, the Y-axis magnification, and the positional deviation in the Y-axis direction.

Of these parameters, for example, the following nine parameters are modified in the embodiment:

tilting angle ω+Δω, direction angle γ+Δγ, rotation angle θ+Δθ, distortion constants Da and Db, X-axis magnification, positional deviation in the X-axis direction, Y-axis magnification, and positional deviation in the Y-axis direction.

It is difficult to directly measure these parameters, and calculate these parameters based on other parameters.

Next, operation of the video image positional relationship correction apparatus according to this embodiment will be described.

Firstly, the actual video image including reference points P1 to P6 as actual targets is captured by the CCD area sensor 4 through the lens 3. A signal representing the actual image captured by the CCD area sensor 4 is transmitted to the signal processing IC 5, and outputted to the superimposing circuit 6. Further, signals representing virtual target points R1 to R6 are inputted from the theoretical drawing circuit 8 to the superimposing circuit 6.

At this time, derivation of the virtual target points R1 to R6 in the theoretical drawing circuit 8 will be described. The reference positions P1 to P6 on the road surface are determined in advance, and the stop position of the vehicle 1 with respect to these reference points P1 to P6 is also determined in advance. Therefore, the respective virtual target points R1 to R6 are derived theoretically based on the coordinate conversion parameters before modification which are determined without taking the errors of the coordinates of the reference points P1 to P6 in the road surface coordinate system into account. The theoretical drawing circuit 8 outputs the coordinates determined theoretically in this manner as coordinate data of the virtual target points R1 to R6 in the monitor coordinate system to the superimposing circuit 6.

In the superimposing circuit 6, based on the signal representing the actual image and the coordinate data representing the virtual target points R1 to R6 outputted from the theoretical drawing circuit 8, the actual image and the virtual target points R1 to R6 drawn by dotted lines are superimposed on the screen of the monitor 7. At this time, if the attachment parameters and the internal parameters of the CCD camera 2 and the conversion constants to the screen of the monitor 7 are ideal, the positions of the video image reference points Q1 to Q6 on the monitor screen indicating the actually captured video image reference points P1 to P6 and the positions of the virtual target points R1 to R6 are overlapped with each other on the screen of the monitor 7. However, for example, if the CCD camera 2 is attached with attachment errors with respect to the references, or if the optical axis of the lens 3 of the CCD camera 2 is not in alignment with the center of the CCD area sensor 4, as shown in FIG. 2, the positions of the video image reference points Q1 to Q6 are deviated from the intended positions, i.e., the positions of the virtual target points R1 to R6 determined theoretically based on the coordinate conversion parameters before modification.

In this case, the driver manipulates the direction buttons 10 of the controller 9 such that the virtual target point R1 is overlapped on the target reference point Q1 initially. The movement amount of the virtual target point R1 inputted by the direction buttons 10 is inputted to the theoretical drawing circuit 8. Then, if the driver presses the decision button 11 when the virtual target point R1 is overlapped on the video image reference point Q1, the signal of the decision button 11 is inputted to the theoretical drawing circuit 8. Thus, the theoretical drawing circuit 8 recognizes the coordinate of the video image reference point Q1 in the monitor coordinate system. By repeating the manipulation to move the virtual target points R2 to R6 successively, the theoretical drawing circuit 8 recognizes the coordinates of the video image reference points Q2 to Q6 in the monitor coordinate system.

Next, when the calculation button 12 of the controller 9 is pressed, by a calculation method as described later, the theoretical drawing circuit 8 calculates the coordinate conversion parameters after modification to take the errors into account such that the virtual target points R1 to R6 substantially match the video image reference points Q1 to Q6. For example, at this time, coordinates of new virtual target points R1 to R6 and lines extending between those coordinates are calculated based on the coordinate conversion parameters after modification, and the video image is displayed again on the screen of the monitor 7 by the superimposing circuit 6. Thus, the driver can confirm whether the correction is properly carried out or not based on the positional relationship with the reference points P1 to P6.

After the correction is finished in this manner, the theoretical drawing circuit 8 produces data of the virtual video image in the monitor coordinate system, e.g., display data of the steering assist guide based on the coordinate conversion parameters after modification.

The theoretical drawing circuit 8 calculates the coordinates of the virtual target points R1 to R6 to be displayed on the screen of the monitor 7 using the coordinate conversion parameters before modification. Then, the theoretical drawing circuit 8 determines the coordinate conversion parameters based on the virtual target points R1 to R6, the video image reference points Q1 to Q6, and the coordinate conversion parameters before modification. Next, a method of carrying out those processes by the theoretical drawing circuit 8 will be described.

The coordinate values Xqm and Yqm of the video image reference points Qm (m=1 to 6) in the monitor coordinate system are expressed by the following equations using functions F and G, based on the coordinate values Xpm, Ypm, Zpm of the reference points Pm (m=1 to 6) in the road surface coordinate system and the above-mentioned nine coordinate conversion parameters Kn (n=1 to 9) which require modification, and the other parameters Kj (j=10 to 16) which do not require modification.

Xqm=F(Xpm, Ypm, Zpm, Kn, Kj)+DXm

Yqm=G(Xpm, Ypm, Zpm, Kn, Kj)+DYm

DXm and DYm are deviations between the X coordinates and the Y coordinates of the virtual target points calculated using the functions F and G, and the coordinate values Xqm and Yqm of the video image reference points Qm. If the reference points Pm are drawn on the road surface, Zpm=0.

That is, by expressing the X coordinates and Y coordinates of the six video image reference points Qm, twelve relational expressions are generated in total for nine coordinate conversion parameters Kn.

At this time, the coordinate conversion parameters Kn are determined such that the square-sum of the deviations DXm and Dym expressed by the following equation is the minimum.

S=Σ(DXm²+DYm²)

That is, an optimization problem for minimizing S is solved. Known optimizing methods such as a simplex method, a steepest descent method, a Newton method, and a quasi Newton method are used to solve the problem. Values of the coordinate conversion parameters before modification are used as initial values of the coordinate conversion parameters Kn at the time of repeated calculations.

In this manner, the coordinate conversion parameters Kn are determined, and the virtual video image data in the monitor coordinate system, e.g., the display data of the steering assist guide is produced again based on the coordinate conversion parameters after modification by the theoretical drawing circuit 8 to properly correct the positional relationship between the actual video image and the virtual video image.

Thus, even if the optical axis of the lens 3 is not in alignment with the center of the CCD area sensor 4, and the CCD camera 2 is not properly attached to the vehicle 1 in accordance with the references, the positional relationship between the actual video image and the virtual video image is corrected properly without physically adjusting the optical axis of the lens 3, and without any adjustment operation for attaching the CCD camera 2 in accordance with the references to the vehicle 1 with high accuracy. That is, the positional relationship between the image at the back of the vehicle as the actual video image and the steering assist guide as the virtual image is corrected properly.

Since the coordinate conversion parameters are calculated using the relational expressions, and the number of the relational expressions is larger than the number of the coordinate conversion parameters, therefore, even if errors occur at the time of recognizing the deviation of the coordinate between the virtual target point and the video image reference point by manipulation of the controller 9, the coordinate conversion parameters which do not require modification include errors, or errors occur due to parameters other than the coordinate conversion parameters enumerated above, it is possible to obtain the appropriate coordinate conversion parameters, and carry out the correction accurately.

In the first embodiment, the twelve relational expressions are produced using the six video image reference points Qm for the nine coordinate conversion parameter Kn. However, the present invention is not limited in this respect. As long as the number of the relational expressions is larger than the number of the coordinate conversion parameters to be calculated, other configurations can be envisaged. For example, ten relational expressions may be produced using five video image reference points Qm, or a larger number of relational expressions may be produced using seven or more video image reference points Qm.

Further, the number of the coordinate conversion parameters is not limited to nine, and can be determined freely.

### Second Embodiment

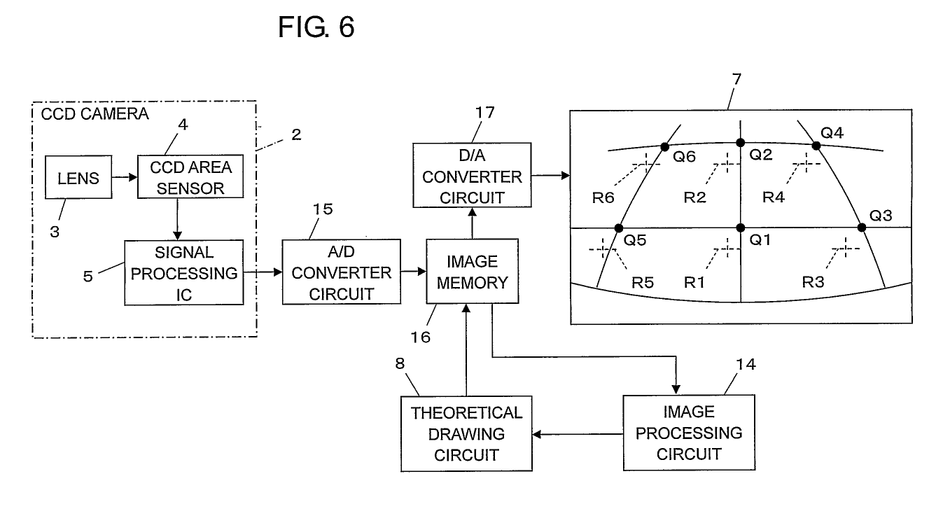

FIG. 5 shows the structure of a video image positional relationship correction apparatus according to a second embodiment. The video image positional relationship correction apparatus according to the second embodiment is different from the video image positional relationship correction apparatus according to the first embodiment shown in FIG. 2 in that the superimposing circuit 6 is replaced by an A/D converter circuit 15, an image memory 16, and a D/A converter circuit 17 serially connected successively between the signal processing IC 5 of the CCD camera 2 and the monitor 7, and the theoretical drawing circuit 8 is connected to the image memory 16.

In the first embodiment, the superimposing circuit 6 superimposes the image signal of the actual video image outputted from the signal processing IC 5 of the CCD camera 2 and the signal of the virtual image outputted from the theoretical drawing circuit 8 on the monitor 7. In the second embodiment, the image signal of the actual video image outputted from the image processing IC 5 of the CCD camera 2 is converted by the A/D converter circuit 15 into image data, and the image data is temporarily stored in the image memory 16. Data of the virtual image outputted from the theoretical drawing circuit 8 is added to the image data of the actual image on the image memory 16. Then, the image data after addition of the virtual image data is transmitted to the monitor 7 through the D/A converter circuit 17, and the actual video image and the virtual image are superimposed on the screen of the monitor 7.

As described above, the video image positional relationship correction apparatus according to the present invention is also applicable to the video image display device in which the image data is temporarily stored in the image memory 16.

### Third Embodiment

FIG. 6 is a view showing the structure of a video image positional relationship correction apparatus according to a third embodiment. The video image positional relationship correction apparatus according to the third embodiment is different from the video image positional relationship correction apparatus according to the second embodiment shown in FIG. 5 in that an image processing circuit 14 instead of the controller 9 is connected to the theoretical drawing circuit 8 and the image memory 16, and the coordinates of the video image reference points Q1 to Q6 are calculated by image processing. In this manner, the driver does not have to manipulate the direction buttons 10 of the controller 9 to carry out the adjustment operation such that the virtual target points R1 to R6 match the video image reference points Q1 to Q6. Therefore, it is possible to correct the positional relationship between the actual video image and the virtual video image easily.

### Fourth Embodiment

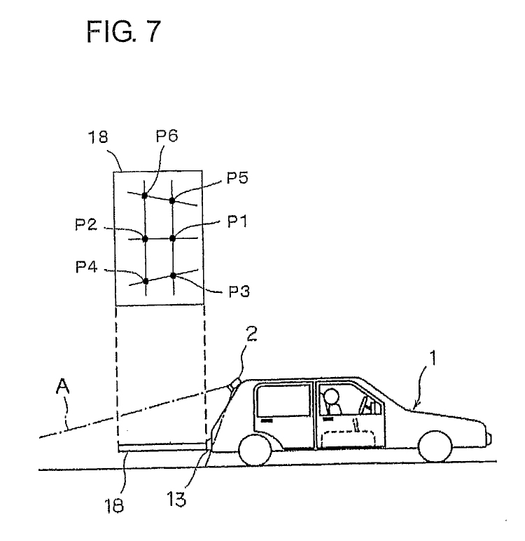

In the first to third embodiments, the reference points P1 to P6 are drawn as the actual targets on the road surface. Alternatively as shown in FIG. 7, a test chart member 18 having a planar shape may be attached to the rear bumper 13 of the vehicle 1. In this case, the reference points P1 to P6 are drawn on the surface of the test chart member 18, and the test chart member 18 is positioned within an area A captured by the CCD camera 2. Using the test chart member 18, regardless of the stop position of the vehicle 1, the positions of the reference points P1 to P6 with respect to the CCD camera 2 are accurately determined. Thus, it is not necessary to stop the vehicle in a position determined by the reference points P1 to P6 on the road surface, and it is possible to correct the positional relationship between the actual video image and the virtual video image in any position.

Further, part of the vehicle 1 in the area captured by the CCD camera 2 may be regarded as the actual target.

### Other Embodiments

The present invention is not limited to the above-mentioned embodiments. The following modifications may be made to the embodiments in carrying out the present invention.

The shape of the reference points as the actual target is not limited to have a circular shape. The reference points may have various shapes.

In the first and second embodiments, the controller 9 is used for manipulation by the driver. Alternatively, instead of using the controller, the monitor 7 may include a touch panel equipped with direction buttons, a decision button, and a calculation button or a jog switch or the like. Any means which is manipulated to overlap the virtual target point and the video image reference point can be used. Further, the order of manipulation is not limited to the above-mentioned embodiments. Various orders can be adopted without deviating the scope of the invention.

Further, the manipulation is not limited to the operation of overlapping the virtual target point on the image reference point. Any manipulation can be adopted as long as it makes it possible to recognize which virtual target point of the virtual target points R1 to R6 corresponds to the coordinate of the image reference point on the screen. For example, the direction buttons or the like may be used to recognize the coordinate of the image reference point, and then, recognize which virtual target point corresponds to the image reference point. The means used to recognize which virtual target point corresponds to the image reference point may be manipulation of the driver. When the virtual target point is not deviated from the image reference point significantly, the nearest image reference point may be recognized automatically as the image reference point corresponding to the virtual target point. In the case of the automatic recognition, the virtual target point may not be displayed.

The coordinate conversion parameters which require modification are not limited to the parameters used in the above-mentioned embodiments. Any parameters may be adopted as long as at least the internal parameters of the camera are included.

In the first through fourth embodiments, the virtual video image produced by the theoretical drawing circuit 8 is corrected. However, the present invention is not limited in this respect. Alternatively, the actual video image captured by the CCD camera 2 may be corrected.

Further, in the embodiments, in particular, the video image of the steering assist apparatus at the back of the vehicle is corrected. However, the present invention is not limited in this respect. The video image positional relationship correction apparatus of the present invention is also applicable to video image correction in other apparatuses that superimpose the actual image and the virtual image.

According to the present invention, even if deviation occurs in the optical axis of the lens, the positional relationship between the actual video image and the virtual video image is corrected properly. Further, attachment of the optical axis and the CCD camera is not adjusted physically but corrected by software. Therefore, the video image positional relationship is corrected with high accuracy at low cost. Further, the accuracy of displaying the two-dimensional distance and the guideline is improved. Therefore, the present invention is applicable to the measurement related field other than the field of the vehicle.

1. An apparatus for correcting relative positional relationship between an actual video image captured by a camera and a virtual video image for use in a video image display device for superimposing the actual video image and the virtual video image on a monitor screen, comprising:
actual targets set in an actual coordinate system in an area captured by the camera;
coordinate conversion means for theoretically deriving monitor coordinates in a monitor coordinate system on the monitor screen by coordinate conversion of actual coordinates of the actual targets in the actual coordinate system based on reference values of coordinate conversion parameters including internal parameters of the camera itself and attachment parameters for attaching the camera to the vehicle;
recognition means for recognizing the monitor coordinates of the image of the actual targets actually captured by the camera; and
correction means for correcting at least values of the internal parameters of the camera itself of the coordinate conversion parameters based on deviations between the monitor coordinates of the image of the actual targets actually captured by the camera and the corresponding monitor coordinates in the monitor coordinate system of the actual targets which has been subjected to the coordinate conversion, and correcting relative positional relationship between the actual video image and the virtual video image based on the corrected values of the coordinate conversion parameters,
the correction means generating relational expressions the number of which is larger than the number of the coordinate conversion parameters based on the monitor coordinates of the image of the actual targets and the monitor coordinates in the monitor coordinate system of the actual targets which have been subjected to coordinate conversion, the coordinate conversion parameters being corrected such that the square-sum of the deviations is the minimum;
the number of actual targets being determined such that the number of the relational expressions is larger than the number of the coordinate conversion parameters which require correction,
the recognition means providing a virtual target in the monitor coordinate system on the monitor screen based on the coordinate conversion parameters before modification using the coordinate conversion means, and carrying out the recognition based on the difference between the monitor coordinate of the image of the actual target captured actually by the camera and the monitor coordinate of the virtual target.

2. (canceled)

3. A video image positional relationship correction apparatus according to claim 2, wherein the recognition means includes a controller for moving one of the actual target and the virtual target on the monitor screen to a position overlapped on the other of the actual target and the virtual target by manipulation of an operator.

4. A video image positional relationship correction apparatus according to claim 3, wherein the controller includes direction buttons for inputting a correction amount of one of the actual target and the virtual target on the monitor screen in an up direction, a down direction, a left direction and a right direction, a decision button for confirming a condition in which the actual target and the virtual target are overlapped with each other, and a calculation button for allowing the correction means to start correction calculation.

5. A video image positional relationship correction apparatus according to claim 1, wherein the recognition means includes an image processing circuit for carrying out the recognition by image processing.

6. A steering assist apparatus having a video image positional relationship correction apparatus according to claim 1, wherein the actual video image and the virtual video image are a video image at the back of the vehicle and a steering assist guide, respectively.

7. A steering assist apparatus according to claim 6, wherein the actual target is set on a road surface.

8. A steering assist apparatus according to claim 6, wherein the actual target is set on a planar member attached to a rear portion of the vehicle.

9. A method of correcting relative positional relationship between an actual video image captured by a camera and a virtual video image when superimposing the actual image and the virtual video image on a monitor screen, comprising the steps of:
capturing actual targets in an actual coordinate system by the camera;
theoretically deriving monitor coordinates in a monitor coordinate system on the monitor screen by coordinate conversion of actual coordinates of the actual targets in the actual coordinate system based on reference values of coordinate conversion parameters including internal parameters of the camera itself and attachment parameters for attaching the camera to the vehicle;
providing a virtual target in the monitor coordinate system on the monitor screen based on the coordinate conversion parameters before modification and recognizing the monitor coordinates of the image of the actual targets actually captured by the camera based on the difference between the monitor coordinate of the image of the actual target captured actually by the camera and the corresponding monitor coordinate of the virtual target;
generating relational expressions based on deviations between the monitor coordinates of the image of the actual targets and the monitor coordinates in the monitor coordinate system of the actual targets which have been subjected to coordinate conversion, the number of relational expressions being larger than the number of the coordinate conversion parameters to be corrected including at least internal parameters of the camera itself of the coordinate conversion parameters;
correcting the coordinate conversion parameters such that the square-sum of the deviations is the minimum; and
correcting relative positional relationship between the actual video image and the virtual video image based on the corrected values of the coordinate conversion parameters.

10. (canceled)

11. A method for the video image positional relationship correction according to claim 9, wherein the difference between the monitor coordinate of the image of the actual target and the corresponding monitor coordinate of the virtual target is calculated by moving one of the actual target and the virtual target to a position overlapped on the other of the actual target and the virtual target on the monitor screen by manipulation of an operator.

12. A method for the video image positional relationship correction according to claim 9, wherein the monitor coordinates of the image of the actual targets are recognized by image processing.

13. A video image positional relationship correction apparatus according to claim 1, wherein the recognition means automatically recognizes the nearest actual target to the virtual target without displaying the virtual target.

14. A video image positional relationship correction apparatus according to claim 1, wherein the correction means calculates lines extending between new virtual targets based on the coordinate conversion parameters after modification, the lines being displayed on the monitor screen.

15. A method for the video image positional relationship correction according to claim 9, wherein the nearest actual target to the virtual target is automatically recognized without displaying the virtual target.

16. A method for the video image positional relationship correction according to claim 9, wherein lines extending between new virtual targets are calculated based on the coordinate conversion parameters after modification and displayed on the monitor screen.
